(19) United States
(12) Patent Application Publication
(10) Pub. No.: US 2018/0219281 A1
(43) Pub. Date: Aug. 2, 2018

(54) ANTENNA DEVICE AND METHOD FOR MANUFACTURING ANTENNA DEVICE

(71) Applicant: Murata Manufacturing Co., Ltd., Kyoto (JP)

(72) Inventors: Kaoru SUDO, Kyoto (JP); Ryuken MIZUNUMA, Kyoto (JP)

(21) Appl. No.: 15/886,117

(22) Filed: Feb. 1, 2018

(30) Foreign Application Priority Data
Feb. 1, 2017 (JP) 2017-016450

(51) Int. Cl. H01Q 1/42; H01Q 21/00; H01Q 1/38; H01Q 1/52

(52) U.S. Cl. CPC H01Q 1/42; H01Q 1/52; H01Q 1/38; H01Q 21/0006

(57) ABSTRACT

An antenna module includes a dielectric substrate and a feed element provided on the dielectric substrate. A radome formed from a dielectric is disposed so as to oppose the antenna module in a radiation direction of the feed element. A parasitic element is provided at a position on the radome at which the electromagnetic coupling with the feed element is achieved. The antenna module is bonded to the radome by an adhesive layer disposed between the antenna module and the radome.

This application claims priority from Japanese Patent Application No. JP2017-016450 filed on Feb. 1, 2017. The content of this application is incorporated herein by reference in its entirety.

### BACKGROUND OF THE DISCLOSURE

### 1. Field of the Disclosure

The present disclosure relates to an antenna device and a method for manufacturing the antenna device.

### 2. Description of the Related Art

A wireless device has been known which includes a substrate, a wireless module that is mounted on the substrate, and a housing that houses the substrate and the wireless module (Japanese Unexamined Patent Application Publication No. 2015-8410). At the housing side from an antenna portion of the wireless module, a void having a length that is substantially equal to a multiple of a half wavelength of radio waves corresponding to a communication frequency of the antenna portion is ensured.

A stack type microstrip antenna including a passive element (parasitic element) above a driven element (feed element) of the microstrip antenna has been known (see Japanese Unexamined Patent Application Publication No. 03-74908). The parasitic element is attached to the inner surface of a radome that covers the entirety of the antenna or embedded within the radome. The driven element is mounted on a metal base, and the radome is mounted on the metal base so as to cover the driven element.

In the wireless device disclosed in Japanese Unexamined Patent Application Publication No. 2015-8410, it is necessary to ensure a void between the wireless module and the housing, and thus it is difficult to reduce the thickness of the wireless device. In the stack type microstrip antenna disclosed in Japanese Unexamined Patent Application Publication No. 03-74908, both the driven element and the radome are fixed to the metal base. In a step of mounting the driven element to the metal base and a step of mounting the radome to the metal base, alignment has to be performed such that the central axis of the driven element and the central axis of a parasitic element provided on the radome coincide with each other. If displacement occurs either in the step of mounting the driven element to the metal base or in the step of mounting the radome to the metal base, displacement occurs between the driven element and the parasitic element.

### BRIEF SUMMARY OF THE DISCLOSURE

Accordingly, it is an object of the present disclosure to provide an antenna device that is suitable for thickness reduction of the device and in which displacement less likely to occur between a feed element and a parasitic element.

An antenna device according to a first aspect of the present disclosure includes:

an antenna module including a dielectric substrate and a feed element provided on, in, or above the dielectric substrate;

a radome comprising a dielectric and disposed so as to oppose the antenna module in a radiation direction of the feed element;

a parasitic element provided at a position on the radome at which electromagnetic coupling with the feed element is achieved; and

an adhesive layer disposed between the antenna module and the radome to bond the antenna module to the radome.

Since the parasitic element is provided on the radome and the radome and the antenna module are bonded to each other by the adhesive layer, the adhesive layer is interposed between the feed element of the antenna module and the parasitic element provided on the radome. It is possible to make the feed element and the parasitic element closer to each other as compared to a configuration in which a void is ensured therebetween, and thus it is possible to reduce the thickness of the antenna device.

Since the antenna module is directly bonded to the radome by the adhesive layer, displacement between the feed element of the antenna module and the parasitic element provided on the radome is less likely to occur, as compared to a configuration in which the antenna module and the radome are mounted to a common base member.

In an antenna device according to a second aspect of the present disclosure, in addition to the configuration of the antenna device according to the first aspect, the adhesive layer has a lower dielectric constant than the dielectric substrate.

It is possible to weaken electromagnetic coupling between the feed element and the parasitic element.

In an antenna device according to a third aspect of the present disclosure, in addition to the configurations of the antenna devices according to the first and second aspects,

the feed element of the antenna module is provided on a surface of the dielectric substrate, and the antenna module further includes a dielectric layer covering the surface of the dielectric substrate and the feed element, and

the dielectric layer is bonded to the radome by the adhesive layer.

The interval between the feed element and the parasitic element is large as compared to the case where the dielectric layer is not disposed. As a result, it is possible to weaken electromagnetic coupling between the feed element and the parasitic element.

In an antenna device according to a fourth aspect of the present disclosure, in addition to the configurations of the antenna devices according to the first to third aspects, a step surface restricting a position of the antenna module in an in-plane direction is provided on an inner surface of the radome.

In a step of bonding the antenna module to the radome, it is possible to easily position the antenna module relative to the radome.

In an antenna device according to a fifth aspect of the present disclosure, in addition to the configurations of the antenna devices according to the first to fourth aspects, the radome also serves as a housing which houses the antenna module.

Since the radome also serves as a housing, it is possible to reduce the number of components and also further reduce the thickness of the antenna device.

In an antenna device according to a sixth aspect of the present disclosure, in addition to the configurations of the antenna devices according to the first to fifth aspects,

the antenna module includes a plurality of other feed elements provided on the dielectric substrate in addition to the feed element, and the plurality of the other feed elements constitutes an array antenna, and

a plurality of other parasitic elements are provided in, on, or above the radome in addition to the parasitic element, and the plurality of the other parasitic elements are electromagnetically coupled with the plurality of the other feed elements, respectively.

Even in the case where a plurality of feed elements and a plurality of parasitic elements are disposed, alignment thereof is easily performed, since displacement between the feed element of the antenna module and the parasitic element provided on the radome is less likely to occur.

A method for producing an antenna device according to a seventh aspect of the present disclosure includes the steps of:

preparing an antenna module including a dielectric substrate and a feed element provided on the dielectric substrate;

preparing a radome on which a parasitic element is provided and which is larger than the antenna module in a plan view; and

positioning and bonding the antenna module to the radome such that the feed element and the parasitic element are electromagnetically coupled with each other.

Since the antenna module including the feed element is bonded to the radome on which the parasitic element is provided, the adhesive layer is interposed between the feed element of the antenna module and the parasitic element provided on the radome. It is possible to make the feed element and the parasitic element closer to each other as compared to a configuration in which a void is ensured therebetween, and thus it is possible to reduce the thickness of the antenna device.

Since the antenna module is directly bonded to the radome by the adhesive layer, displacement between the feed element of the antenna module and the parasitic element provided on the radome is less likely to occur, as compared to a method in which the antenna module and the radome are mounted to a common base member.

Other features, elements, characteristics and advantages of the present disclosure will become more apparent from the following detailed description of preferred embodiments of the present disclosure (with reference to the attached drawings).

### BRIEF DESCRIPTION OF THE SEVERAL VIEWS OF THE DRAWINGS

FIG. 1A is a partial cross-sectional view of a radome and parasitic elements used in an antenna device according to a first embodiment;

FIG. 1B is a cross-sectional view of an antenna module used in the antenna device according to the first embodiment;

FIG. 1C is a cross-sectional view of the antenna device in a state where the radome and the antenna module are bonded to each other;

FIG. 1D is a plan view of the antenna device;

FIG. 2 is a cross-sectional view of an antenna device according to a modification of the first embodiment;

FIG. 3A is a cross-sectional view of an antenna module used in an antenna device according to a second embodiment;

FIG. 3B is a cross-sectional view of the antenna device according to the second embodiment;

FIG. 4A is a cross-sectional view of an antenna device according to a third embodiment;

FIG. 4B is a plan view of the antenna device according to the third embodiment;

FIG. 5A is a plan view of an antenna device according to a first modification of the third embodiment; and

FIG. 5B is a perspective view before an antenna device according to a second modification of the third embodiment is assembled.

### DETAILED DESCRIPTION OF THE DISCLOSURE

### First Embodiment

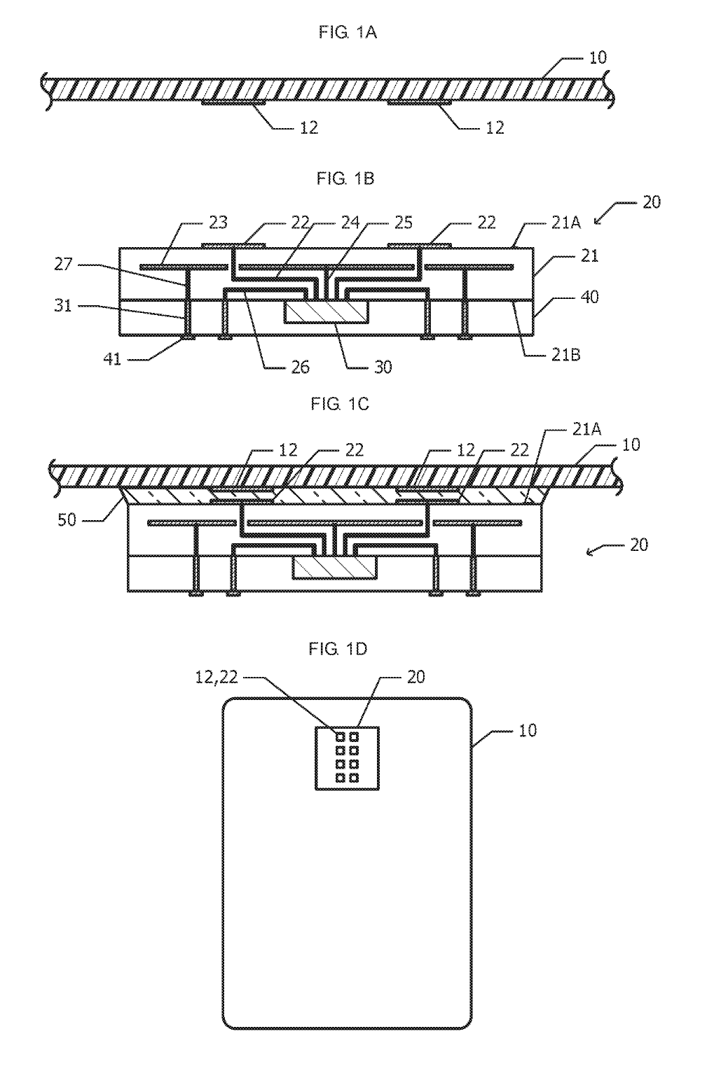

An antenna device according to a first embodiment will be described with reference to FIGS. 1A to 1D.

FIG. 1A is a partial cross-sectional view of a radome 10 and parasitic elements 12 used in the antenna device according to the first embodiment. The radome 10 is, for example, a plate-like member formed from a dielectric. A plurality of parasitic elements 12 are provided on one surface (inner surface) of the radome 10.

FIG. 1B is a cross-sectional view of an antenna module 20 used in the antenna device according to the first embodiment. A plurality of feed elements 22 are formed on one surface (first surface) 21A of a dielectric substrate 21. For example, patch antennas are used as the feed elements 22. A high-frequency integrated circuit element 30 is mounted on a second surface 21B of the dielectric substrate 21 opposite to the first surface 21A. A ground plane 23 is disposed in an inner layer of the dielectric substrate 21.

Each of the plurality of feed elements 22 is connected to a high-frequency signal terminal of the high-frequency integrated circuit element 30 via a transmission line 24 provided within the dielectric substrate 21. The ground plane 23 is connected to a ground terminal of the high-frequency integrated circuit element 30 via a wire 25 provided within the dielectric substrate 21.

A plurality of conductor columns 31 project from the second surface 21B of the dielectric substrate 21. The plurality of conductor columns 31 and the high-frequency integrated circuit element 30 are embedded within a sealing resin layer 40. Each conductor column 31 reaches the surface of the sealing resin layer 40. A plurality of lands 41 are provided on the surface of the sealing resin layer 40 so as to correspond to the plurality of conductor columns 31. Some of the terminals of the high-frequency integrated circuit element 30 are connected to the corresponding lands 41 via wires 26 within the dielectric substrate 21 and the conductor columns 31. The ground plane 23 is connected to the lands 41 for grounding via wires 27 within the dielectric substrate 21 and the conductor columns 31.

FIG. 1C is a cross-sectional view of the antenna device in a state where the radome 10 and the antenna module 20 are bonded to each other. The antenna module 20 and the radome 10 are bonded to each other by an adhesive layer 50 such that the surface (first surface 21A) of the antenna module 20 on which the feed elements 22 are formed opposes the inner surface of the radome 10 on which the parasitic elements 12 are formed. In this manner, the radome 10 is disposed so as to be spaced apart from the antenna module 20 across a gap in a radiation direction of the feed elements 22.

Each feed element 22 is disposed so as to oppose the corresponding parasitic element 12, and each parasitic element 12 is electromagnetically coupled with the corresponding feed element 22. The dielectric constant of the adhesive layer 50 is lower than the dielectric constant of the dielectric substrate 21.

FIG. 1D is a plan view of the antenna device. In the plan view, the radome 10 is larger than the antenna module 20, and the antenna module 20 is disposed within the radome 10. The plurality of feed elements 22 and the plurality of parasitic elements 12 are disposed regularly within the surfaces, for example, in a matrix manner. The plurality of feed elements 22 and the plurality of parasitic elements 12 constitutes an array antenna.

The radome 10 has a function to protect the antenna module 20. When the antenna module 20 is provided in a portable terminal such as a smartphone or a tablet terminal, the radome 10 also serves as a housing of the portable terminal that houses the antenna module 20.

Next, advantageous effects of the first embodiment will be described. By electromagnetically coupling the parasitic elements 12 with the feed elements 22, it is possible to widen the band of the antenna device. By adjusting the thickness of the adhesive layer 50, it is possible to accurately control the strength of the electromagnetic coupling between the feed elements 22 and the parasitic elements 12. By making the dielectric constant of the adhesive layer 50 lower than the dielectric constant of the dielectric substrate 21, it is possible to weaken the electromagnetic coupling between the feed elements 22 and the parasitic elements 12.

In a structure in which a void is ensured between the feed elements 22 and the parasitic elements 12, in order to prevent the contact between the feed elements 22 and the parasitic elements 12, it is preferable to increase the interval therebetween to some extent. In the first embodiment, the adhesive layer 50, which is formed from a dielectric, is disposed between the feed elements 22 and the parasitic elements 12. Thus, even when the interval between the feed elements 22 and the parasitic elements 12 is decreased, the contact therebetween does not occur. Thus, in the first embodiment, it is possible to reduce the thickness of the antenna device as compared to the structure in which a void is ensured between the feed elements 22 and the parasitic elements 12.

When the interval between the feed elements 22 and the parasitic elements 12 is increased, the electromagnetic coupling between one feed element 22 and the parasitic element 12 opposing to the feed element 22 adjacent to the one feed element 22 easily occurs. When the feed element 22 and the adjacent parasitic element 12 are electromagnetically coupled with each other, desired antenna characteristics are not obtained. In the first embodiment, it is possible to make the feed elements 22 and the parasitic elements 12 closer to each other, and thus the electromagnetic coupling between the feed element 22 and the adjacent parasitic element 12 is less likely to occur. In order to inhibit the electromagnetic coupling between the feed element 22 and the adjacent parasitic element 12, it is preferable to make the interval between each feed element 22 and each parasitic element 12 smaller than the interval between the adjacent feed elements 22.

When a structure in which each of the antenna module 20 and the radome 10 is fixed to another common base member is adopted, an error in positioning of the antenna module 20 and the base member and an error in positioning of the radome 10 and the base member are superimposed on an error in positioning of the antenna module 20 and the radome 10. In the first embodiment, since the antenna module 20 is directly positioned and fixed to the radome 10 via the adhesive layer 50, it is possible to reduce an error in positioning.

When a plurality of the feed elements 22 and a plurality of the parasitic elements 12 are disposed to constitute an array antenna, it is possible to enhance the accuracy of alignment of the feed elements 22 and the parasitic elements 12 corresponding to each other.

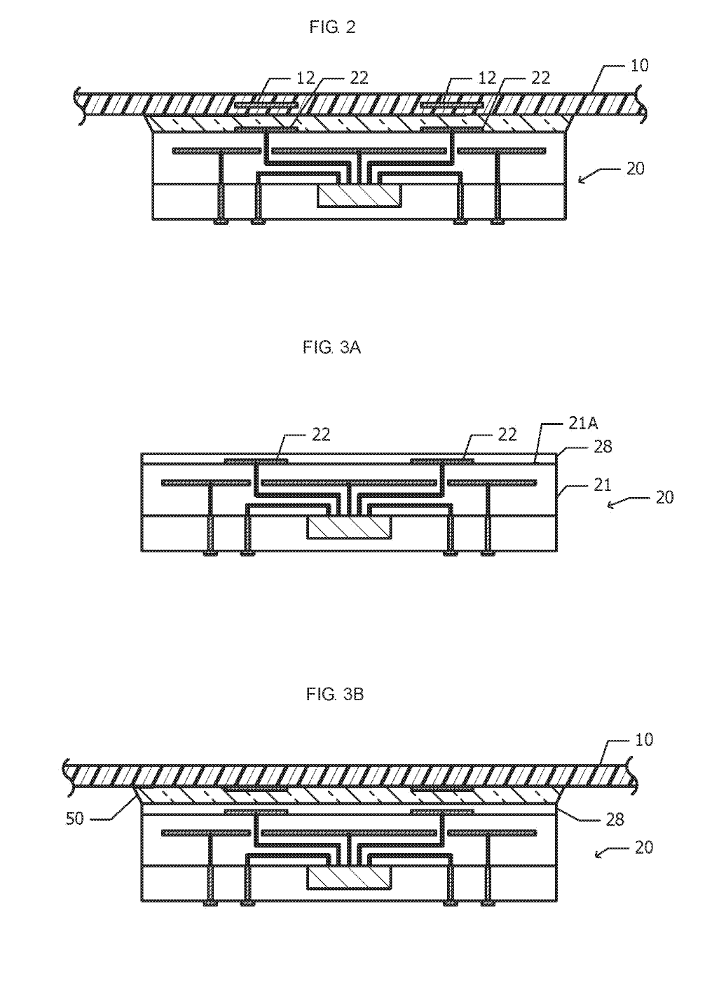

Next, a modification of the first embodiment will be described with reference to FIG. 2.

FIG. 2 is a cross-sectional view of an antenna device according to the modification of the first embodiment. In the first embodiment, the parasitic elements 12 are provided on the inner surface of the radome 10. However, in the present modification, the parasitic elements 12 are embedded within the radome 10.

In the present modification, it is possible to increase the interval between the feed elements 22 and the parasitic elements 12 as compared to the structure of the first embodiment. As a result, it is possible to weaken the electromagnetic coupling between the feed elements 22 and the parasitic elements 12. Whether the structure of the first embodiment or the structure of the modification is adopted may be determined in accordance with a target magnitude for the electromagnetic coupling between the feed elements 22 and the parasitic elements 12.

### Second Embodiment

Next, an antenna device according to a second embodiment will be described with reference to FIGS. 3A and 3B. Hereinafter, the description of the components common to the antenna device according to the first embodiment is omitted.

FIG. 3A is a cross-sectional view of an antenna module 20 used in the antenna device according to the second embodiment. In the first embodiment, the feed elements 22 of the antenna module 20 are exposed as shown in FIG. 1B before the antenna module 20 is bonded to the radome 10. In the second embodiment, the first surface 21A of the dielectric substrate 21 and the feed elements 22 are covered with a dielectric layer 28. As described above, the feed elements 22 are disposed in an inner layer of the antenna module 20, not on the surface of the antenna module 20.

FIG. 3B is a cross-sectional view of the antenna device according to the second embodiment. The adhesive layer 50 is disposed between the dielectric layer 28 of the antenna module 20 and the radome 10. The antenna module 20 is bonded to the radome 10 by the adhesive layer 50 similarly to the first embodiment.

In the second embodiment, the strength of the electromagnetic coupling between the feed elements 22 and the parasitic elements 12 depends not only on the dielectric constant and the thickness of the adhesive layer 50 but also on the dielectric constant and the thickness of the dielectric layer 28. Thus, the flexibility in adjusting the strength of the electromagnetic coupling between the feed elements 22 and the parasitic elements 12 is increased.

In the second embodiment as well, the parasitic elements 12 may be embedded within the radome 10 as in the modification of the first embodiment shown in FIG. 2.

### Third Embodiment

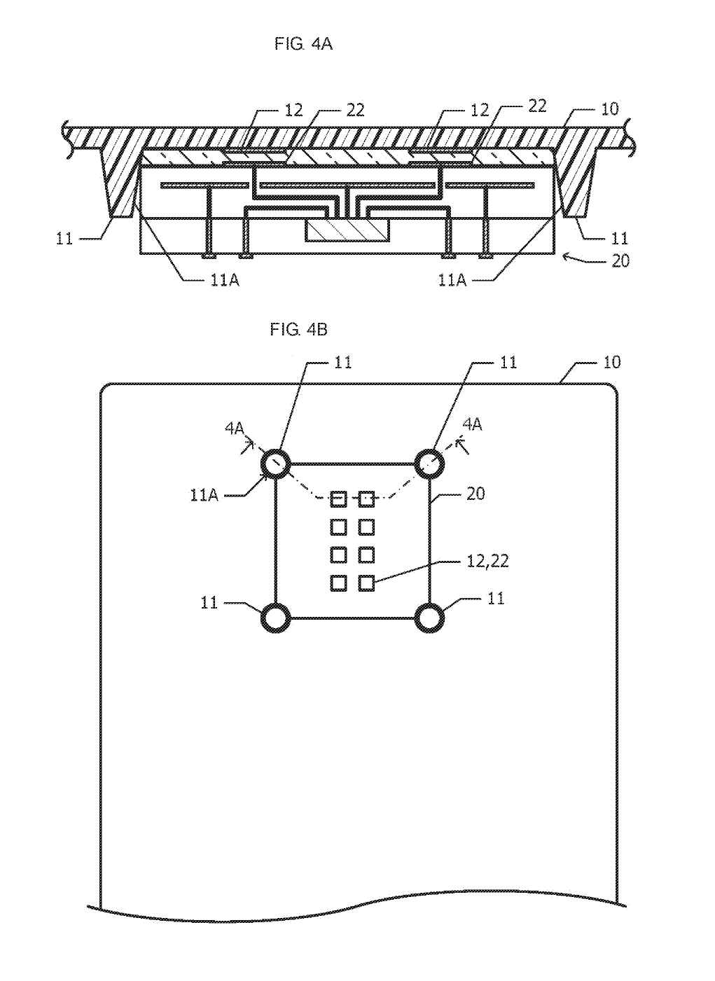

Next, an antenna device according to a third embodiment will be described with reference to FIGS. 4A and 4B. Hereinafter, the description of the components common to the antenna device according to the first embodiment is omitted.

FIG. 4A is a cross-sectional view of the antenna device according to the third embodiment. In the third embodiment, projections 11 are provided on the inner surface of the radome 10. The antenna module 20 is in contact with the side surfaces (step surfaces) 11A of the projections 11.

FIG. 4B is a plan view of the antenna device according to the third embodiment. A cross-sectional view taken along the dashed line 4A-4A in FIG. 4B corresponds to the cross-sectional view of FIG. 4A. The antenna module 20 has a substantially rectangular planar shape. The projections 11 provided on the inner surface of the radome 10 are disposed at positions corresponding to the four corners of the antenna module 20. The four corners of the antenna module 20 are chamfered so as to fit the step surfaces 11A (FIG. 4A) of the projections 11. Surfaces that appear by chamfering the four corners of the antenna module 20 are in contact with the step surfaces 11A of the projections 11.

In the third embodiment, by the antenna module 20 being brought into contact with the step surfaces 11A of the radome 10, the step surfaces 11A restrict the position of the antenna module 20 in the in-plane direction. Accordingly, it is possible to easily position the antenna module 20 relative to the radome 10. As a result, it is possible to easily position the feed elements 22 and the parasitic elements 12.

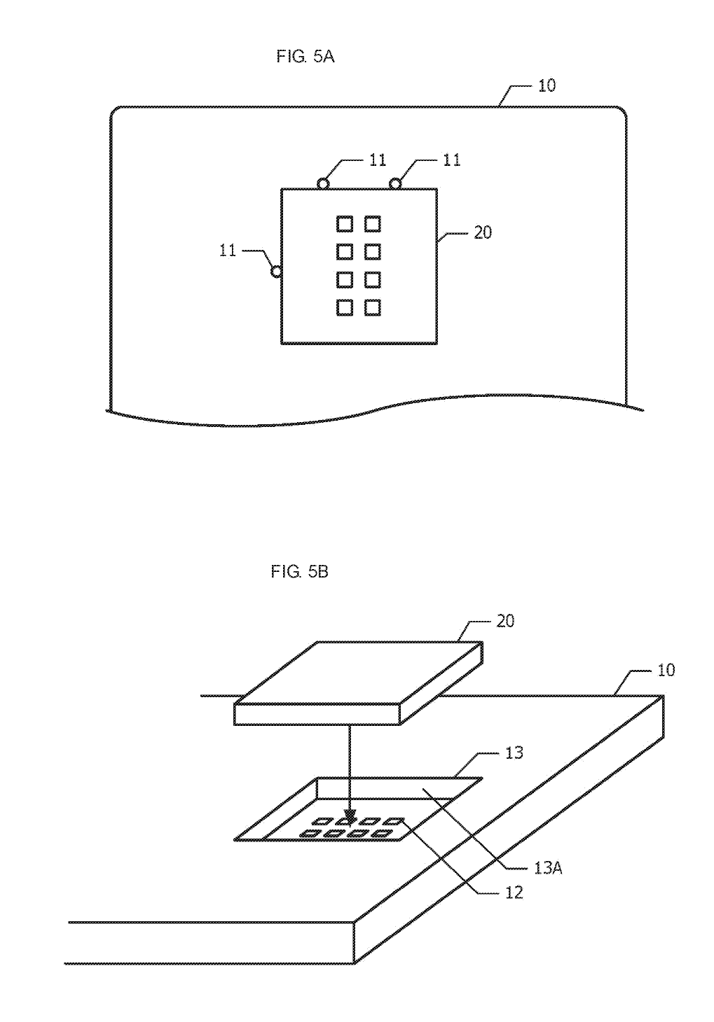

Next, modifications of the third embodiment will be described with reference to FIGS. 5A and 5B.

FIG. 5A is a plan view of an antenna device according to a first modification of the third embodiment. In the third embodiment, the projections 11 (FIG. 4B) are disposed in corresponding relation to the four corners of the antenna module 20. However, in the first modification, the step surfaces of two projections 11 are in contact with one edge of the antenna module 20, and the step surface of another projection 11 is in contact with an adjacent edge of the antenna module 20. Even when the edge of the antenna module 20 is brought into contact with the step surfaces at three locations as described above, it is possible to restrict the position of the antenna module 20 relative to the radome 10 in the in-plane direction.

FIG. 5B is a perspective view before an antenna device according to a second modification of the third embodiment is assembled. In the second modification, a recess 13 is provided in the inner surface of the radome 10 instead of the projections (FIGS. 4A and 4B) of the third embodiment. The planar shape of the recess 13 substantially coincides with the planar shape of the antenna module 20. The parasitic elements 12 are disposed on the bottom surface of the recess 13. By disposing the antenna module 20 within the recess 13 and bringing the antenna module 20 into contact with the side surface (step surface) 13A of the recess 13, it is possible to restrict the position of the antenna module 20 relative to the radome 10 in the in-plane direction.

Each embodiment is illustrative, and it is needless to say that the components shown in the different embodiments may be partially replaced or combined. The same advantageous effects achieved by the same configuration in multiple embodiments are not mentioned successively in each embodiment. Furthermore, the present disclosure is not limited to the above-described embodiments. For example, it is obvious to a person skilled in the art that various changes, modifications, combinations, etc. may be made.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An antenna device comprising:
an antenna module including a dielectric substrate and a feed element provided on, in, or above the dielectric substrate;
a radome comprising a dielectric and disposed so as to oppose the antenna module in a radiation direction of the feed element;
a parasitic element provided at a position on the radome at which electromagnetic coupling with the feed element is achieved; and
an adhesive layer disposed between the antenna module and the radome to bond the antenna module to the radome.

2. The antenna device according to claim 1, wherein the adhesive layer has a lower dielectric constant than the dielectric substrate.

3. The antenna device according to claim 1, wherein
the feed element of the antenna module is provided on a surface of the dielectric substrate, and the antenna module further includes a dielectric layer covering the surface of the dielectric substrate and the feed element, and
the dielectric layer is bonded to the radome by the adhesive layer.

4. The antenna device according to claim 1, wherein a step surface restricting a position of the antenna module in an in-plane direction is provided on an inner surface of the radome.

5. The antenna device according to claim 1, wherein the radome serves as a housing which houses the antenna module.

6. The antenna device according to claim 1, wherein
the antenna module includes a plurality of other feed elements provided on the dielectric substrate in addition to the feed element, and the plurality of the other feed elements constitutes an array antenna, and
a plurality of other parasitic elements are provided in, on, or above the radome in addition to the parasitic element, and the plurality of the other parasitic elements are electromagnetically coupled with the plurality of the other feed elements, respectively.

7. A method for producing an antenna device, the method comprising:
preparing an antenna module including a dielectric substrate and a feed element provided on, in, or above the dielectric substrate;
preparing a radome on, in or above which a parasitic element is provided and which is larger than the antenna module in a plan view; and
positioning and bonding the antenna module to the radome such that the feed element and the parasitic element are electromagnetically coupled with each other.

8. The antenna device according to claim 2, wherein
the feed element of the antenna module is provided on a surface of the dielectric substrate, and the antenna module further includes a dielectric layer covering the surface of the dielectric substrate and the feed element, and
the dielectric layer is bonded to the radome by the adhesive layer.

9. The antenna device according to claim 2, wherein a step surface restricting a position of the antenna module in an in-plane direction is provided on an inner surface of the radome.

10. The antenna device according to claim 3, wherein a step surface restricting a position of the antenna module in an in-plane direction is provided on an inner surface of the radome.

11. The antenna device according to claim 2, wherein the radome serves as a housing which houses the antenna module.

12. The antenna device according to claim 3, wherein the radome serves as a housing which houses the antenna module.

13. The antenna device according to claim 4, wherein the radome serves as a housing which houses the antenna module.

14. The antenna device according to claim 2, wherein
the antenna module includes a plurality of other feed elements provided on the dielectric substrate in addition to the feed element, and the plurality of the other feed elements constitutes an array antenna, and
a plurality of other parasitic elements are provided in, on, or above the radome in addition to the parasitic element, and the plurality of the other parasitic elements are electromagnetically coupled with the plurality of the other feed elements, respectively.

15. The antenna device according to claim 3, wherein
the antenna module includes a plurality of other feed elements provided on the dielectric substrate in addition to the feed element, and the plurality of the other feed elements constitutes an array antenna, and
a plurality of other parasitic elements are provided in, on, or above the radome in addition to the parasitic element, and the plurality of the other parasitic elements are electromagnetically coupled with the plurality of the other feed elements, respectively.

16. The antenna device according to claim 4, wherein
the antenna module includes a plurality of other feed elements provided on the dielectric substrate in addition to the feed element, and the plurality of the other feed elements constitutes an array antenna, and
a plurality of other parasitic elements are provided in, on, or above the radome in addition to the parasitic element, and the plurality of the other parasitic elements are electromagnetically coupled with the plurality of the other feed elements, respectively.

17. The antenna device according to claim 5, wherein
the antenna module includes a plurality of other feed elements provided on the dielectric substrate in addition to the feed element, and the plurality of the other feed elements constitutes an array antenna, and
a plurality of other parasitic elements are provided in, on, or above the radome in addition to the parasitic element, and the plurality of the other parasitic elements are electromagnetically coupled with the plurality of the other feed elements, respectively.
